(19) United States
(12) Patent Application Publication
(10) Pub. No.: US 2013/0066872 A1
(43) Pub. Date: Mar. 14, 2013

(54) Method and Apparatus for Organizing Images

(71) Applicants: Simon Moritz, Stockholm (SE); Jonas Björk, Stockholm (SE); Mattias Lidström, Stockholm (SE); Joakim Söderberg, Solna (SE)

(72) Inventors: Simon Moritz, Stockholm (SE); Jonas Björk, Stockholm (SE); Mattias Lidström, Stockholm (SE); Joakim Söderberg, Solna (SE)

(73) Assignee: TELEFONAKTIEBOLAGET L M ERICSSON (PUBL), Stockholm (SE)

(21) Appl. No.: 13/697,946

(22) PCT Filed: Jun. 7, 2010
(86) PCT No.: PCT/EP2010/057895

§ 371 Date: Nov. 14, 2012

(51) Int. Cl. G06F 17/30

(52) U.S. Cl. 707/737; 707/E17.033; 707/E17.019

(57) ABSTRACT

A method and apparatus are defined for organizing a plurality of digital photos. The method comprises the steps of identifying a group of digital photos, receiving a number defining how many clusters to be formed from the group, receiving profile information to be used for clustering the digital photos into the number of clusters, clustering the group of digital photos according to the profile information, and identifying representative digital photo(s) of the clusters from the clustered digital photos based on the profile information.

### TECHNICAL FIELD

The invention relates generally to processing of digital photos.

### BACKGROUND

The use of social Internet sites is becoming increasingly common. A relatively great percentage of the population around the world uses sites like Facebook, twitter and other social Internet sites to communicate and stay in touch with friends and family. Many of these Internet sites usually provide the possibility to upload a large amount of photos in different photo libraries.

Further, the extensive use of digital cameras enables a user to take a very large amount of pictures without being concerned about the cost for developing the photos, as was the situation in the past when using cameras comprising a roll of film to be developed at a certain cost per photo. Many mobile phones comprise a digital camera, thereby allowing the user of the mobile phone to take photos at any opportunity. As a relatively great percentage of the population, at least in some parts of the world, is in possession of a mobile phone comprising a digital camera, they always have a digital camera at hand.

Due to the ease to take a photo not having to worry about the quality, the cost for developing and so on, a very large amount of photos are taken. One drawback is that at some point in time, a user may want to somehow sort all his/her digital photos into categories or libraries and also dispose of photos of poor quality. As the amount of photos to be sorted may be very large, the task of sorting them and selecting the ones to keep and/or the ones to upload to an Internet site may be cumbersome and time consuming.

Just as an example, a family goes on vacation for a period of time. During the vacation all members of the family may take many different photos of different motifs, at different times during the day and so on. As the family comes home, the photos are to be sorted and some photos are to be selected to be uploaded to an Internet site or to be stored in a catalog or folder on a laptop/personal computer/CD or other medium to be shown to friends and family. Assume there are five family members and the family is away for a week, i.e. 7 days. Assume all members of the family have taken on the average 20 photos each day for that week. Then there will be 700 photos to go through as the family returns home. Perhaps the family wants to pick about 50 photos to be representative of the vacation and which the family may want to show to friends.

In another example, a user of a digital camera and/or a mobile phone comprising a digital camera may take photos at short intervals, such as several photos each day, but may not sort his/her photos very often, perhaps once every second month. In such a case, the number of photos to be sorted may pile up to a large amount between the sorting instances.

Various methods to sort digital photos have been proposed and used. The existing methods and technology employ mechanisms for analyzing the photos and sorting them according to their content, i.e. what they depict. One drawback associated with the existing methods and technology, is that a user needs to manually select the photos of interest, which may subsequently optionally be uploaded to an Internet site. In other words, as the photos have been sorted, for example into groups, the user needs to go through the different groups and select one or more photos of interest.

### SUMMARY

It is an object to address at least some of the problems outlined above. In particular, it is an object to provide a method and an apparatus for enabling a user thereof to organize a plurality of digital photos with as little manual processing as possible. These objects and others may be obtained by providing a method and an apparatus according to the independent claims below.

According to one aspect, a method in an image organizing apparatus for organizing a plurality of digital photos is defined. The method comprises the steps of receiving and/or holding an identified group of digital photos, receiving a number defining how many clusters to be formed from the group, receiving profile information to be used for clustering the digital photos into the number of clusters, clustering the group of digital photos according to the profile information, and identifying representative digital photo(s) of the clusters from the clustered digital photos based on the profile information.

This has the advantage that the group of digital photos will be organized into clusters with minimal manual input and the user will be presented with at least one representative photo of a cluster, some clusters or all clusters enabling him/her to easily and quickly see what kind of photos are comprised in the clusters.

In one example, the profile comprises attributes representing different characteristics of a photo.

According to one embodiment, the attributes comprises metadata of a photo and/or characteristics relating to the appearance of the photo. This has the advantage that the digital photos can be organized or sorted into clusters based on both what the photos depict or the appearance of the photos as well as the specific metadata for the digital photos.

According to another embodiment, the method further comprises associating weights to some or all attributes, defining the importance of each attribute. This has the advantage that a cluster may be more precisely defined so that the organizing of the digital photos can be performed with high precision or accuracy.

In one example, the profile information comprises a user profile defining a set of attributes valid for a specific user, which attributes specify different characteristics that are to be considered in the clustering of the group of digital photos. This has the advantage that a user of the method is given the ability to define a profile which best corresponds to his/her personal likings and preferences.

In another example, the profile information comprises a scenario profile defining a set of attributes valid for a specific scenario, which attributes specify different characteristics that are to be considered in said clustering of said group of digital photos. This has the advantage that a user may define different profiles depending on who will watch the digital photos or depending on specific situations that the different digital photos depict.

According to one embodiment, the scenario profile is created in the step of receiving profile information to be used for clustering the digital photos, by entering specific attributes to be considered in the clustering of the group of digital photos. This has the advantage that a user of the procedure is enabled to either enter a specific profile, create a new profile or just to enter some attributes to be used one time for clustering the digital photos.

According to another embodiment, the method further comprises determining a certainty for different attributes with respect to different digital photos and filtering out digital photos having uncertain information for specific attribute(s), before the step of clustering the group of digital photos according to the profile information.

In one example, the step of clustering the group of digital photos according to the profile information comprises defining clusters in accordance to one or more attributes, and clustering the group of digital photos according to the clusters.

In another example, the method further comprises adding the filtered out digital photos having uncertain information to an appropriate cluster, after the step of identifying representative digital photo(s) of the clusters from the clustered digital photos based on the profile information. This has the advantage that filtered out digital photos are not lost, they are added after representative photo(s) have been identified. It also ensures that a digital photo which is difficult to cluster cannot be identified as being a representative digital photo of a cluster.

According to one embodiment, the determining a certainty for different attributes with respect to different digital photos comprises determining an entropy for the attributes, wherein a high entropy corresponds to uncertain information.

According to another embodiment, the step of identifying representative digital photo(s) comprises identifying a photo in each cluster, which photo best corresponds to the attribute(s) for that cluster as defined in the profile information.

According to yet another embodiment, if a user profile was entered and subsequently used in the step of clustering the group of digital photos according to the profile, the method further comprises receiving feedback from a user relating to the identified representative digital photo(s) and adjusting weights for each attribute in the user profile according to the received feedback. This has the advantage that the user profile can be “trimmed” or optimized to fit the desires and preferences of the user associated with the profile.

In one example, the step of receiving and/or holding an identified group of digital photos comprises uploading said group of digital photos to a data storage.

In another example, the step of receiving and/or holding an identified group of digital photos comprises uploading at least one digital photo to a data storage comprising an already existing clustered group of digital photos, and wherein the clustering of the group of digital photos according to the profile comprises clustering the at least one uploaded digital photo into one of the clusters in the already existing clustered group of digital photos. This has the advantage that a user may add a single digital photo or a few digital photos and have them organized into an already clustered or organized group of digital photos.

According to another aspect, an apparatus adapted to organize a plurality of digital photos is defined.

In one embodiment, the apparatus comprises a database adapted to receive and/or hold an identified group of digital photos, a receiving unit adapted to receive input from a user, the input comprising a number of clusters to be formed from the group of digital photos and profile information to be used for clustering the digital photos into the number of clusters, a clustering unit adapted to cluster the group of digital photos according to the profile information, and an identifying unit (520) adapted to identify representative digital photo(s) of said clusters from the clustered digital photos based on said profile information.

According to an embodiment, the profile information comprises attributes representing different characteristics of a digital photo.

In one example, the attributes comprises metadata of a photo and/or characteristics relating to the appearance of the photo.

In another example, weights are associated to some or all attributes, defining the importance of each attribute.

In yet another example, the received profile information is a user profile defining a set of attributes valid for a specific user, which attributes specify different characteristics that are to be considered in the clustering of the group of digital photos.

In yet another example, the received profile information is a scenario profile defining a set of attributes valid for a specific scenario, which attributes specify different characteristics that are to be considered in the clustering of the group of digital photos.

According to an embodiment, the scenario profile is created when the receiving unit receives specific attributes to be considered in the clustering of the group of digital photos.

According to another embodiment, the apparatus is further adapted to determine a certainty for different attributes with respect to different digital photos and filtering out photos having uncertain information for specific attribute(s), before the clustering unit clusters the group of digital photos according to the profile information.

According to yet another embodiment, the clustering of the group of digital photos according to the profile information comprises defining clusters in accordance to one or more attributes, and clustering the group of digital photos according to the clusters.

In one example, the clustering unit is further adapted to add the filtered out digital photos having uncertain information to an appropriate cluster, after identifying representative digital photo(s) of the clusters from the clustered digital photos based on the profile information.

In another example, the determining of a certainty for different attributes with respect to different digital photos comprises determining an entropy for the attributes, wherein a high entropy corresponds to uncertain information.

In yet another example, the identifying of representative digital photo(s) comprises identifying a photo in each cluster, which photo best corresponds to the attribute(s) for that cluster as defined in the profile information.

According to an embodiment, if the receiving unit received a user profile, which was subsequently used by the clustering unit when clustering the group of digital photos according to the profile, the receiving unit is further adapted to receive feedback from a user relating to the identified representative digital photo(s) and the clustering unit is further adapted to adjust weights for each attribute in the user profile according to the received feedback.

According to another embodiment, the database is adapted to hold a group of already clustered digital photos and to receive at least one digital photo and wherein the clustering unit is further adapted to cluster said received at least one digital photo into one or more of the clusters in the group of already clustered digital photos.

According to yet another embodiment, the apparatus is a terminal such as a digital camera, a mobile telephone or any other terminal comprising a camera.

### BRIEF DESCRIPTION OF DRAWINGS

The invention will now be described in more detail by means of exemplary embodiments and with reference to the accompanying drawings, in which:

FIG. 1 is a flowchart illustrating an embodiment of the procedure.

FIG. 2 is a flowchart illustrating another embodiment of the procedure.

FIG. 3 is a flowchart illustrating yet another embodiment of the procedure.

FIG. 4 is a block diagram illustrating a profile.

FIG. 5 is a block diagram illustrating an embodiment of an apparatus.

FIG. 6 is an Entropy curve.

### DETAILED DESCRIPTION

This solution may be used to address at least some of the problems outlined above. In particular, this solution may be used for enabling a user to automatically organize a plurality of digital photos into clusters or groups.

In prior art, a user would have to manually select the photos which he/she would like to have in an album or folder. He/she further needs to manually identify different key moments, i.e. for example pictures representing a certain event, before uploading the pictures to an album or folder.

The solution presented here, will provide a procedure and an apparatus which will help the user to automatically organize a plurality of photos into different clusters according to different attributes, with minimal manual intervention.

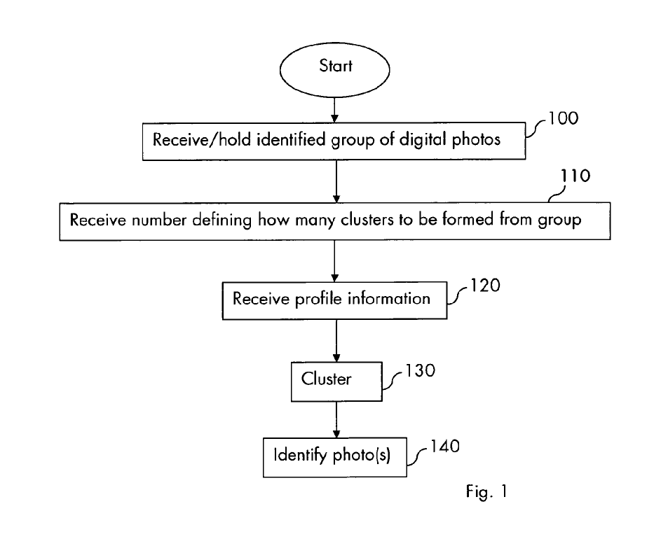

FIG. 1 is a flowchart illustrating an embodiment of the procedure for organizing a plurality of digital photos. This procedure comprises a first step 100 of receiving and/or holding an identified group of digital photos. This may be done in several ways. Two examples are to upload a group of photos to be organized to a database or to identify the group of photos comprised in a data storage or memory.

The next step 110 of the procedure is to receive a number defining how many clusters to be formed from the group of digital photos. One feature of the procedure is that it organizes, or clusters, a plurality of digital photos, here referred to as a group of digital photos, into smaller groups, hereinafter referred to as clusters. The group of photos to be organized may be very large, comprising a vast amount of digital photos. In order to execute this feature of the procedure, namely to organize the group of digital photos into clusters, it is necessary to know how many clusters to be formed from the group of digital photos.

FIG. 1 also illustrates the next step 120 of the procedure, namely to receive profile information to be used for clustering the digital photos. This step enables the procedure to know how to cluster the group of digital photos. In order to be able to perform the clustering of the group of digital photos into clusters, it is necessary to also know how to cluster the group of photos, what kind of digital photos shall be comprised in each cluster. This information will be provided by the profile information.

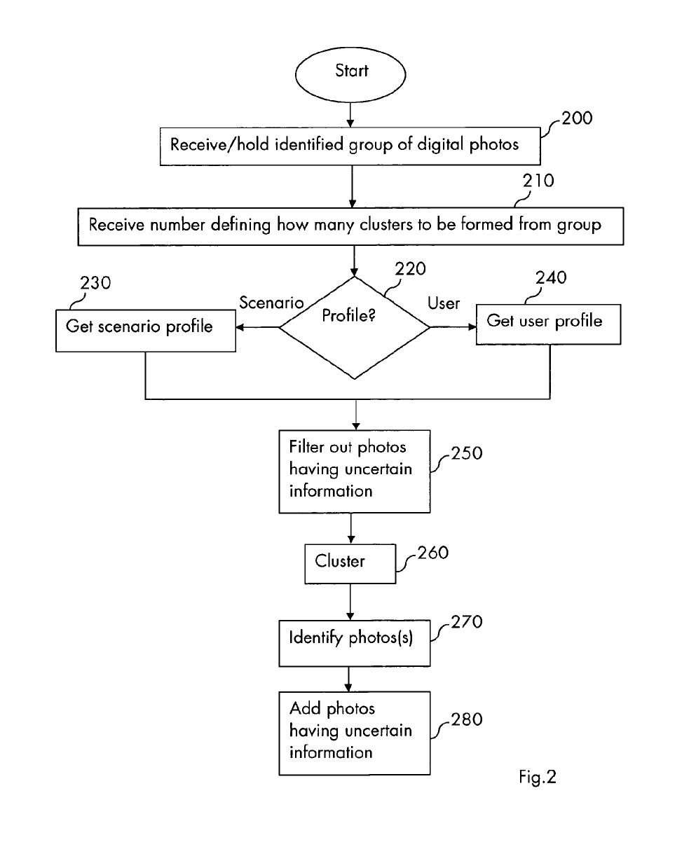

The entering of profile information can be implemented in different ways. In one example, the procedure may prompt the user 220 to enter a profile to be used for clustering the digital photos. This will be explained in more detail below in relation to FIG. 2.

Then the clustering 130 of the group of digital photos can begin and the digital photos are clustered in different clusters according to the profile information, which was entered in the previous step 120. By this point, the procedure has all the information it needs to cluster, or organize, the group of digital photos into clusters. The procedure is provided with the group to be clustered, the numbers of clusters into which the group of digital photos is to be clustered/organized and also according to which criteria, or how to, perform the clustering as given by the profile information.

FIG. 1 also illustrates a last step 140 of identifying a representative photo of the clusters from the clustered digital photos based on the entered profile information. As the original group of photos is clustered into different clusters, this step provides a representative photo for a cluster. A user of the method may then be provided with a photo which represents a specific cluster so that he/she will know, or easily see, what sort of photos are comprised in that specific cluster. There may be one or more photos representing a cluster. All clusters or some of the clusters may be represented by a representative photo.

This has several advantages. One being that the user may sort a large amount of digital photos automatically. Only the number of clusters and the profile information need to be specified by the user and then the group or plurality of digital photos is sorted or organized automatically. The user will then be presented with at least one representative photo of a cluster, some clusters or all clusters enabling him/her to easily and quickly see what kind of photos are comprised in the clusters. The user need not manually go through and select a vast amount of photos and/or manually select different criteria to be used when organizing or clustering the digital photos. Further, the user will be provided with a representative digital photo of a cluster, so that the user need not manually open each cluster to see what kind of digital photos that are comprised in the different clusters.

The profile information that is entered 120 and subsequently used for clustering 130 the digital photos and to identify 140 representative photo(s) for the clusters can comprise attributes representing different characteristics of a digital photo.

An attribute may be any sort of characteristics which may indicate or define what a digital photo depicts. It is most often desirable to organize photos into clusters, wherein a cluster may comprises photos disclosing similar situations and/or objects. The attributes help define what sort or kind of digital photos should be comprised in each cluster.

One advantage by this feature is that a user may create one or more profiles, each profile comprising attributes representing different characteristics of a photo. Another advantage is that the user may enter the profile to be used, when entering the profile information, without having to manually enter each and every attribute every time he/she wants to organize a group of digital photos.

The attributes comprise metadata of a photo and/or characteristics relating to the appearance of a photo.

It can be advantageous to be able to specify several different attributes from both metadata and what the photo depicts, the appearance of the photo, when defining a profile and/or what to be used in the clustering step and the subsequent identifying step. Some examples of metadata are, time and date when the picture is taken. It may be desirable to sort the digital photos in some sequence in regards to when they were taken, or to sort by time of day such as day or night. Some other examples of attributes are what a photo displays, such as people, smiling faces, landscape, mountains, buildings and so on. Some other examples are location where a photo is taken and in which direction. Another attribute may be the sharpness of the photo, it may be desirable not to show blurry photos. Of course there may be many other examples of both what the photo depicts and what metadata that may be taken into account.

The different attributes may also be associated with different weights, defining the importance of each attribute. Weights may be associated with some or all the different attributes.

This also has several advantages. Some attributes may be more important than others and should be especially considered in the clustering and the identifying steps. This feature enables the user of the procedure to better and more precisely define different profiles (and clusters within the profiles) to be used. This may also improve the quality of the clustering step and especially the identifying step such that a cluster is more likely to only comprise photos that should be part of that cluster. In the identifying step, the digital photo which is identified to represent a specific cluster is more likely to best correspond to the most important attributes for that specific cluster, that is the attributes with the highest weights.

The attributes can be expressed as probabilities, ranging from 0 to 1. This will be described in more detail below. Different attributes may be combined. For example the attributes “smiling faces”, “location” and “direction” can be combined to categorize digital photos depicting the same or similar object(s). The combination of the attributes will function as the basis for the selection criteria when organizing/clustering the digital photos.

A digital photo, p, is represented by its attributes, attₓ, so that: p=[att₁, att₂, . . . , attₙ].

The similarity, sim(p₁, p₂), between two photos can be expressed as:

$$sim ( {p}_{1} , {p}_{2} ) = \frac{{\sum }_{k = 0}^{n} {w}_{k} * sim ( {att}_{k} ( {p}_{1} ) , {att}_{k} ( {p}_{2} ) , ont )}{{\sum }_{k = 0}^{n} {w}_{k}} ,$$

where ont is an ontology on the attribute level that defines a similarity metric between attributes and wₖ is a weight for attribute attₖ. The similarity between the different attributes can be computed as follows depending on the value of the attribute: “similarity between numbers”: normalized distance between 0 and 1, or an equivalent similarity; “similarity between binary values”: 1 if they are equal and 0 otherwise, or an equivalent similarity; “similarity between terms and lists”: number of steps that are required to transform the first element into the second, or vice versa, given a set of operations like insert, delete, etc.; “similarity between hierarchical lists”: number of steps that are similar from root. The weights are normalized and will reflect the importance of each attribute when clustering the photos.

The profile information that is entered 120 can be a user profile defining a set of attributes which are valid for a specific user. The attributes specify different characteristics to be considered in the step 130 of clustering the group of digital photos.

By using a user profile, a user of the procedure is given the ability to define a profile which best corresponds to his/her personal likings and preferences. A user is likely to have some preferences as to what he/she is interested in and what he/she prefers to see. A user profile may then be “tailor made” for a user.

The profile that is entered 120 can be a scenario profile defining a set of attributes which are valid for a specific scenario. The attributes specify different characteristics to be considered in the step of clustering the group of digital photos.

By having a scenario profile, a user of the procedure may enter different scenario profiles. It may be desirable to use different profiles depending on who will watch the digital photos or depending on specific situations that are depicted in the digital photos. It may be desirable to show different kind of photos, (scenarios), to friends and other kind of photos to family and relatives. Then the scenario profiles will comprise different attributes. It may also be the case that some digital photos may be uploaded to a social network and some digital photos will be stored in a specific folder on a memory or database. The variations are many and therefore the need for having different profiles can be substantial.

The scenario profile can be predefined. But the scenario profile may also be created in the step of entering profile information to be used for clustering the digital photos by entering specific attributes to be considered in the step of clustering the group of digital photos.

It may be desirable and advantageous to be able to enter some specific attributes to be used for clustering the digital photos if no “good” or matching profile exists which corresponds to the desired attributes to be used for the clustering. This enables a user of the procedure to either enter a specific profile, create a new profile or just to enter some attributes to be used one time for clustering the digital photos. Of course it also enables a user of the procedure to create a new profile, the entered attributes may be stored as e.g. a scenario profile.

FIG. 2 is a flowchart illustrating another embodiment of the procedure wherein the procedure is implemented in such a way that if a user is prompted to enter a profile 220 or specific attributes as the profile information. If the user fails to do so, the procedure automatically retrieves and uses a predefined user profile 240 in the clustering 260 and identifying 270 steps. The steps 200 and 210 in FIG. 2 corresponds to the steps 100 and 110 in FIG. 1.

In one embodiment of the procedure, as illustrated in FIG. 2, it is possible to determine a certainty for different attributes and filtering out 250 photos having uncertain information for specific attribute(s), before the step 260 of clustering the group of digital photos according to the entered profile. Step 260 of FIG. 2 corresponds to step 130 of FIG. 1.

This may have several advantages. It is desirable to cluster the group of digital photos according to the entered profile information or attributes. It may be that some digital photos are difficult to classify, or cluster, and there is a certain uncertainty with regards to different attributes. These photos should not be identified as a representative photo of a cluster and this is hereby avoided.

The attributes in the profile or profile information can be seen or expressed as probabilities of what the photo depicts and/or of the metadata. Some digital photos will be easier to classify or cluster than others. As an example, for a digital photo the probability that it depicts a smiling face is 0.5. This means that the probability that it does not depict a smiling face is also 0.5. Therefore the uncertainty for the attribute for a smiling face is high. Such a digital photo will be filtered out 150. Assume on the other hand that for a digital photo the probability that it depicts a smiling face is 0.8. This means that that the probability that it does not depict a smiling face is 0.2. The uncertainty for the attribute for a smiling face in this digital photo is low and the digital photo is therefore easy to cluster with respect to the attribute “smiling face”.

The step 130, 260 of clustering the group of digital photos according to the profile information comprises defining clusters in accordance to one or more attributes, and clustering the group of digital photos according to the defined clusters.

As described above, the profile information comprises different attributes. The profile information also defines different clusters, which clusters in turn each comprises a group of one or more attributes. When clustering 130, 260 the group of digital photos according to the profile information, the group of digital photos is clustered according to the defined clusters within the profile information.

After the identifying step 270, when a representative photo of the clusters From the clustered digital photos based on the entered profile information is identified, the procedure comprises the step of adding 280 the filtered out digital photos having uncertain information to an appropriate cluster.

This has the advantage that the filtered out digital photos are not lost, but can be found in an appropriate cluster. The appropriate cluster is the cluster to which the digital photo closest corresponds, according to the attribute(s) for that cluster. A digital photo having uncertain information doesn't mean that it is a “bad” photo or a photo that is not desirable. The uncertain information indicates that it cannot be clustered with certainty. For example, assume that an attribute to cluster after is smiling faces. The photo may very well comprise smiling faces, but the procedure is not able to determine that with certainty or with a high probability. Such a photo is therefore filtered out, but not discarded. After the identifying of representative photo(s), the digital photo is added to the cluster of digital photos comprising smiling faces. As a consequence, the digital photo may still be found by the user, but it will not be a representative photo for that specific cluster.

The determining a certainty for different attributes with respect to different digital photos comprises determining an entropy for the attributes, wherein a high entropy corresponds to uncertain information.

With reference to the above example with a photo wherein the probability that it comprises a smiling face is 0.5. In this example, the entropy for the attribute “smiling face” is high. Likewise, for the photo wherein the probability that it comprises a smiling face is 0.8, the entropy for the attribute “smiling face” is low.

Entropy can be used as a measure of uncertainty in a sample collection. It can be said to characterize the impurity in an arbitrary collection of examples, which for example could be represented as a random variable Y. The expected self-information (HY) can then be expressed as:

H(Y)=Σp(Y=y)log(p(Y=y)

In the case of only two values in the collection, positives and negatives, and assuming we have 14 samples, out of which 9 positive and 5 negative [9+, 5−], the entropy, E, becomes:

$$E ( [ 9 + , 5 - ] ) = - {p}_{+} {log}_{2} {p}_{+} - {p}_{-} {log}_{2} {p}_{-} = - ( \frac{9}{14} ) {log}_{2} ( \frac{9}{14} ) - ( \frac{5}{14} ) {log}_{2} ( \frac{5}{14} ) = 0.940$$

If the collection has equal distribution, for example [5+, 5−], then E(Y)=1. If all the samples belong to the same class, for example [10+, 0−], then E(Y)=0. See graph in FIG. 6 disclosing an Entropy curve.

The step 270 of identifying at least one representative digital photo comprises identifying a photo in each cluster, which photo best corresponds to the attribute(s) for that cluster as defined in the profile information.

It is advantageous to present the user of the procedure with at least one digital photo of each cluster. The digital photo which photo best corresponds to the attribute(s) for that cluster as defined in the profile information is the one which is closest to the centroid, the centroid being a photo which corresponds 100% to the cluster as defined by its attribute(s). As explained above, an attribute can be seen as probability for the presence of that attribute in the digital photo. A digital photo corresponding 100% to the cluster as defined by its attribute(s) would have a probability of 1.0 for each attribute in that cluster. In other words, the entropy for each of the attributes in that cluster would be 0. Such a digital photo, which has the entropy equal to zero for each of the attributes in that cluster may not exist, it can be thought of as a “hypothetical” digital photo. The representative digital photo of a cluster will be the one which is closest to the “hypothetical” digital photo, i.e. the digital photo with the lowest entropy for the attributes defining the cluster. Other personal criteria such as quality, resolution of the digital photo and so on may be considered in the step 280 of identifying a representative digital photo.

As the user of the procedure is presented with a digital photo representing a cluster, the user will also have the possibility to see more photos of that cluster. The user will not be limited to just seeing the representative photo. The procedure may be implemented such that the user may choose to, after having been presented with the representative digital photo, be presented with an arbitrary number of digital photos in the specific cluster, or all digital photos in that cluster which is represented by the representative digital photo.

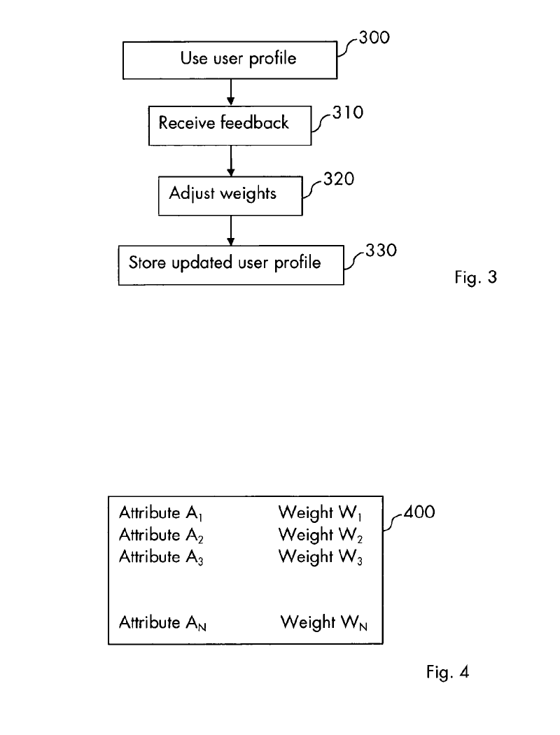

The procedure further comprises the possibility for the user to enter feedback regarding the clustering and the identified photo(s). This is illustrated in FIG. 3. If a user profile was received and subsequently used 300 in the clustering step 130, 260 of clustering the group of digital photos according to the entered user profile, the user may enter feedback 310 relating to the identified representative photo(s). The weights for each attribute in the user profile can then be adjusted 320 according to the received feedback.

This has the advantage that the user profile can be “trimmed” or optimized to fit the desires and preferences of the user associated with the profile. The user profile represents the preferences of the user and it is advantageous if the profile can be adjusted so that the procedure clusters the group of digital photos according to the user's preferences to the best possible. As the weights have been adjusted 320, the updated user profile is then stored 330.

One example of how to update a weight, wₖ, is:

$${w}_{k} ( t + 1 ) = \frac{{w}_{k} ( t ) * n + v}{n + 1} ,$$

where v is the current observation.

According to the procedure, the step 100, 200 of receiving and/or holding an identified group of digital photos to be organized comprises uploading the group of digital photos to a data storage.

One of the first things that needs to be done when organizing a plurality of photos is to identify which photos are to be organized. Depending on the implementation of the method, as will be described later, this can be done in several ways. This exemplifies one way of identifying the group of digital photos which are to be organized and clustered. In other words, a user of the procedure uploads a group of photos to be organized to some kind of data storage on which the procedure is executed.

According to an embodiment of the procedure, the step 100, 200 of receiving and/or holding an identified group of digital photos to be organized comprises uploading at least one digital photo to a data storage comprising an already existing clustered group of photos. Then the step 130, 260 of clustering the group of digital photos according to the profile information comprises clustering the at least one uploaded digital photo into one of the clusters in the already existing clustered group of digital photos.

This constitutes another example of how to receive and/or hold an identified group of digital photos to be organized 100, 200. In this example, the group of photos to be clustered comprises the already existing clustered group of digital photos plus the at least one uploaded digital photo. Then, in the clustering step 130, 260, the procedure merely has to cluster the newly uploaded at least one digital photo into the already existing clustered group of digital photos. In other words, this can be seen as an incremental clustering, wherein a user may simply add a digital photo to an already existing clustered group of digital photos. One advantage with this example is that all the already existing clustered group of digital photos need not be clustered all over again. Only the newly added at least one digital photo needs to be processed in order to cluster it to the appropriate cluster. Of course, this is only valid if the same profile information should be used for the clustering. In case a user of the procedure chooses other profile information to be used in the clustering step 130, 260, all the digital photos need to be considered in the clustering according to the new entered profile information.

FIG. 4 illustrates an example of a user profile 400 or scenario profile 400. The profile comprises different attributes A₁, A₂, A₃, . . . , A_{N} and corresponding weights W₁, W₂, W₃, . . . , W_{N} to each attribute. This means that each attribute may be given more or less importance by applying a weight to it. In other words, each attribute has the influence of Aₖ*Wₖ.

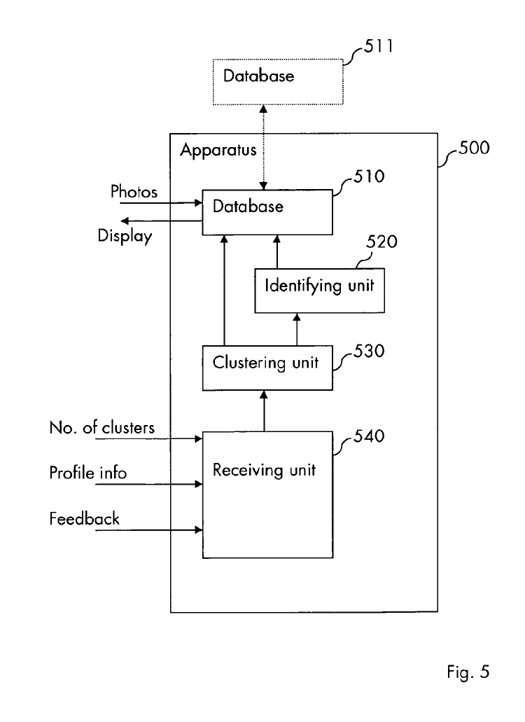

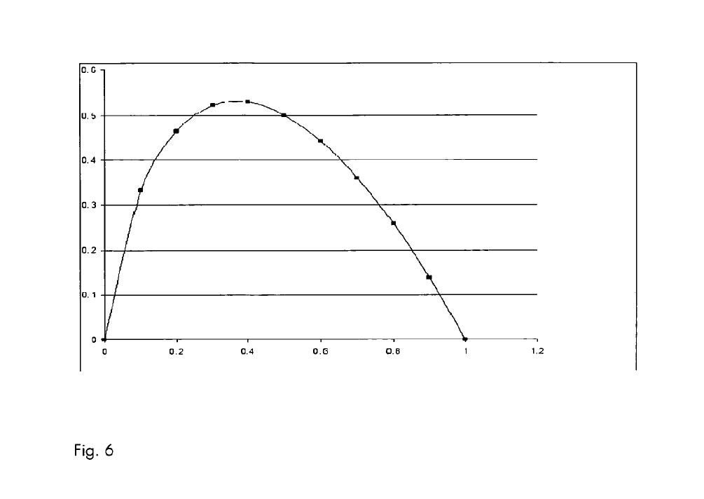

Below, an apparatus adapted to organize a plurality of digital photos will be described with reference to FIG. 5. The apparatus has similar or the same advantages as the method and these will not be repeated. FIG. 5 discloses a block diagram illustrating an embodiment of an apparatus.

The apparatus 500 illustrated in FIG. 5 comprises a database 510, 511 adapted to receive and/or hold an identified group of digital photos. The database may either be a part of the apparatus 500, as illustrated by database 510 or it may be implemented as an external database 511. The apparatus 500 further comprises a receiving unit 540 adapted to receive input from a user, the input comprising a number of clusters to be formed from the group of digital photos and profile information to be used for clustering the digital photos into the numbers of clusters. The apparatus 500 also comprises a clustering unit 530 adapted to cluster the group of digital photos according to the profile information and it also comprises an identifying unit 520 adapted to identify representative digital photo(s) of the clusters from the clustered digital photos based on the profile information.

The profile information which is received by the receiving unit 540 from a user of the apparatus 500 comprises attributes representing different characteristics of a digital photo.

The profile information may be stored within the apparatus and the user merely enters a reference to the profile information to be used. As the apparatus 500 receives the reference to the profile, it can retrieve the stored profile information to be used. Alternatively, the profile information may be manually entered by a user of the apparatus 500.

The attributes of the profile information comprises metadata of a photo and/or characteristics derived from analyzing a digital photo.

Some examples of characteristics derived from analyzing a digital photo are smiling faces, people, landscape, buildings, mountains, beach, animals and so on.

In one embodiment, some or all of the attributes of the profile information, which is received by the receiving unit 540, are associated with weights defining the importance of each attribute.

In one example, the profile information, which is received by the receiving unit 540 from a user of the apparatus 500, is a user profile defining a set of attributes valid for a specific user, which attributes specify different characteristics that are to be considered in the clustering of the group of digital photos.

In another example, the profile information which is received by the receiving unit 540 from a user of the apparatus 500, is a scenario profile defining a set of attributes valid for a specific scenario, which attributes specify different characteristics that are to be considered in said clustering of the group of digital photos.

In one example, the profile, which is received by the receiving unit 540 from a user of the apparatus 500, is created when the receiving unit 540 receives specific attributes to be considered in the clustering of the group of digital photos.

The apparatus 500 is then adapted to create a profile from the received attributes and store the created profile.

The clustering unit 530 of the apparatus 500 is further in one embodiment adapted to determine a certainty for different attributes with respect to different digital photos and filtering out photos having uncertain information for specific attribute(s), before the clustering unit 530 clusters the group of digital photos according to the profile.

In one example, when the clustering unit 530 clusters the group of digital photos according to the profile information, clusters are defined in accordance to one or more attributes, and the clustering unit 530 clusters the group of digital photos according to the clusters. In other words, the clustering unit 530 is adapted to define clusters in accordance to one or more attributes and clustering the group of digital photos according to the clusters when clustering the group of digital photos according to the profile information.

The clustering unit 530 of the apparatus 500 is in one embodiment further adapted to add the filtered out digital photos having uncertain information to an appropriate cluster, after identifying representative digital photo(s) of the clusters from the clustered digital photos based on the profile information.

In one embodiment, wherein the clustering unit 530 of the apparatus 500 determines a certainty for different attributes with respect to different digital photos, this comprises determining an entropy for the attributes, wherein a high entropy corresponds to uncertain information.

The identifying unit 520 identifies a representative digital photo for a cluster. The identifying comprises identifying a photo in each cluster, which photo best corresponds to the attribute(s) for that cluster as defined in the profile information.

If the receiving unit 540 received a user profile, which was subsequently used by the clustering unit 530 when clustering the group of digital photos according to the profile, the receiving unit 540 is in one embodiment further adapted to receive feedback from a user relating to the identified digital photo(s) and the clustering unit 530 is further adapted to adjust weights for each attribute in the user profile according to the received feedback.

The database 510, 511 of the apparatus 500 is in one embodiment further adapted to hold a group of already existing clustered digital photos and to receive at least one digital photo. The clustering unit 530 may then be further adapted to cluster the at least one received digital photo into appropriate cluster(s) in the group of already existing clustered digital photos.

The apparatus 500 can be a terminal such as a digital camera, a mobile phone, or any other terminal comprising a camera.

The apparatus 500 may advantageously be any terminal comprising a camera. In such a case, the method as described above will be implemented in the terminal. A terminal comprising a camera typically comprises a data storage, such as a memory, to hold digital photos which are taken by its camera. The user of the terminal can then utilize the procedure after having taken a plurality of photos and organize these photos within the terminal according to a specific profile or according to specific attributes. The user may also incrementally organize a newly taken digital photo into the appropriate already existing cluster.

If a user of a terminal such as described above wishes to upload digital photos to a social Internet site, such as for example Facebook, he/she can easily choose to upload a whole cluster, a part of a cluster or a representative digital photo of that cluster.

The apparatus may also be implemented in a node in a network to provide access to, or use of, the method to a user of a social Internet site. A user may then upload a plurality of photos to the social Internet site and the photos are organized according to the method in the Internet site. Then the user may be given the option to choose which photos to publish and make available for others to see. Also in this example, the Internet site may already hold several digital photos which are already clustered and the user may upload one or more digital photos to the Internet site and have it or them organized into the already existing clusters.

In another example, the apparatus may be implemented in a personal computer or a laptop. As for the other examples described above, a user may upload a plurality of photos and have them organized in the laptop. As in the other examples, the computer or laptop may already hold several digital photos which are already clustered and the user may upload one or more digital photos to the computer or laptop and have it or them organized into the already existing clusters.

It should be noted that FIG. 5 merely illustrates various functional units in the apparatus in a logical sense. However, the skilled person is free to implement these functions in practice using any suitable software and hardware means. Thus, the invention is generally not limited to the shown structures of the apparatus and the functional units.

While the invention has been described with reference to specific exemplary embodiments, the description is generally only intended to illustrate the inventive concept and should not be taken as limiting the scope of the invention. The present invention is defined by the appended claims.

1-26. (canceled)

27. A method in an image organizing apparatus for organizing a plurality of digital photos, comprising the following steps:
receiving a number defining how many clusters to be formed from an identified group of digital photos;
receiving profile information to be used for clustering the digital photos into the number of clusters, wherein the profile information comprises attributes representing different characteristics of a photo;
associating weights to some or all attributes, the weights defining an importance of each attribute;
clustering the group of digital photos according to the profile information and associated weights to form clustered digital photos;
identifying at least one representative digital photo for each cluster from the clustered digital photos based on the profile information and associated weights.

28. The method of claim 27, wherein the attributes comprise metadata of at least one of a photo and characteristics relating to appearance of a photo.

29. The method of claim 27, wherein the profile information comprises a user profile defining a set of attributes valid for a specific user.

30. The method of claim 27, wherein the profile information comprises a scenario profile defining a set of attributes valid for a specific scenario.

31. The method of claim 30, wherein the receiving profile information comprises creating the scenario profile by entering specific attributes to be considered in the clustering of the group of digital photos.

32. The method of claim 27, further comprising:
determining a certainty for different attributes with respect to different digital photos;
prior to the clustering the group of digital photos, filtering out digital photos having uncertain information for one or more specific attributes.

33. The method of claim 32, further comprising, after the identifying one or more representative digital photos, adding filtered out digital photos having uncertain information to an appropriate cluster.

34. The method of claim 32, wherein determining a certainty comprises determining an entropy for the different attributes, wherein a high entropy corresponds to uncertain information.

35. The method of claim 27, wherein the clustering the group of digital photos comprises:
defining clusters in accordance to one or more attributes;
clustering the group of digital photos according to the clusters.

36. The method of claim 27, wherein the of identifying one or more representative digital photos comprises identifying a photo in each cluster that best corresponds to the attributes for that cluster as defined in the profile information.

37. The method of claim 27, wherein, if a user profile was entered and subsequently used in the clustering the group of digital photos, the method further comprises:
receiving feedback from a user relating to the one or more representative digital photos; and
adjusting weights for each attribute in the user profile according to the feedback.

38. The method of claim 27, further comprising uploading the group of digital photos to a data storage.

39. The method of claim 27:
further comprising uploading at least one digital photo to a data storage comprising an already existing clustered group of digital photos;
wherein the clustering of the group of digital photos comprises clustering the at least one uploaded digital photo into one of the clusters in the already existing clustered group of digital photos.

40. An image organizing apparatus adapted to organize a plurality of digital photos, comprising:
a database configured to receive and/or hold an identified group of digital photos;
a receiving unit configured to receive input from a user, the input comprising a number of clusters to be formed from the group of digital photos and profile information to be used for clustering the digital photos into the number of clusters; wherein the profile information comprises attributes representing different characteristics of a photo; wherein weights are associated to some or all attributes, the weights defining an importance of each attribute;
a clustering unit configured to cluster the group of digital photos according to the profile information and associated weights; and
an identifying unit configured to identify one or more representative digital photo of for each cluster from the clustered digital photos based on the profile information and associated weights.

41. The image organizing apparatus of claim 40, wherein the attributes comprise metadata of at least one of a photo and characteristics relating to appearance of a photo.

42. The image organizing apparatus of claim 40, wherein the profile information is a user profile defining a set of attributes valid for a specific user.

43. The image organizing apparatus of claim 40, wherein the received profile information is a scenario profile defining a set of attributes valid for a specific scenario.

44. The image organizing apparatus of claim 43, wherein the receiving unit is configured to create the scenario profile when the receiving unit receives specific attributes to be considered in the clustering of the group of digital photos.

45. The image organizing apparatus of claim 40, wherein the clustering unit is further configured to, prior to the clustering unit clustering the group of digital photos, both:
determine a certainty for different attributes with respect to different digital photos;
filter out photos having uncertain information for one or more specific attributes.

46. The image organizing apparatus of claim 45, wherein the clustering unit is further configured to, after the identifying unit identifies the one or more representative digital photos, add filtered out digital photos having uncertain information to an appropriate cluster.

47. The image organizing apparatus of claim 45, wherein the determining a certainty comprises determining an entropy for the attributes, wherein a high entropy corresponds to uncertain information.

48. The image organizing apparatus of claim 40, wherein the clustering unit is further configured to:
define clusters in accordance to one or more attributes;
cluster the group of digital photos according to the clusters when clustering of the group of digital photos according to the profile information.

49. The image organizing apparatus of claim 40, wherein the identifying of one or more representative digital photos comprises identifying a photo in each cluster that best corresponds to the attributes for that cluster as defined in the profile information.

50. The image organizing apparatus of claim 40:
wherein the receiving unit is further configured to, if the receiving unit received a user profile which was subsequently used by the clustering unit when clustering the group of digital photos according to the profile, receive feedback from a user relating to the identified one or more representative digital photos;
wherein the clustering unit is further configured to, if the receiving unit received a user profile which was subsequently used by the clustering unit when clustering the group of digital photos according to the profile, adjust weights for each attribute in the user profile according to the feedback.

51. The image organizing apparatus of claim 40:
wherein the database is configured to:
hold a group of already clustered digital photos;
receive at least one additional digital photo;
wherein the clustering unit is further configured to cluster the at least one additional digital photo into one or more of the clusters in the group of already clustered digital photos.

52. The image organizing apparatus of claim 40, wherein the apparatus is a terminal comprising a camera.
